(19) United States
(12) Patent Application Publication
(10) Pub. No.: US 2007/0228721 A1
(43) Pub. Date: Oct. 4, 2007

(54) Systems and devices for assessment and treatment of a myocardial ischemic event

(76) Inventor: Michael Laposata, Boston, MA (US)

Correspondence Address: CHOATE, HALL & STEWART LLP, TWO INTERNATIONAL PLACE, BOSTON, MA, 02110, US

(21) Appl. No.: 11/706,926

(22) Filed: Feb. 14, 2007

Related U.S. Application Data
(60) Provisional application No. 60/766,866, filed on Feb. 15, 2006.

(51) Int. Cl. B42D 15/00

(52) U.S. Cl. 283/115

(57) ABSTRACT

The invention relates to a medical kit for use by a patient to assess and treat an ischemic event. The medical kit of the invention provides instructions for the patient to assess symptoms associated with a myocardial ischemic event, assign a category of likelihood of an ischemic event, and treat the ischemic event based on the assigned category. The medical kit further comprises a set of medications for treating the myocardial ischemic event according to the treatment instructions for the assigned risk category.

### RELATED APPLICATIONS

This application claims priority to provisional application U.S. 60/766,866 filed Feb. 15, 2006, the contents of which are incorporated herewith.

### FIELD OF INVENTION

This invention relates to systems and devices for rapid intervention in acute myocardial ischemic events initiated and controlled by an affected individual or assistant.

### DESCRIPTION OF RELATED ART

Cardiovascular disease (CVD) is the number one killer in the United States today. According to the American Heart Association, CVD accounts for 38.5% of all deaths within the United States. This figure is expected to rise with the aging population and current lifestyle trends. In the United States, the direct and indirect annual cost of CVD is estimated at $368.4 billion.

Acute ischemic events account for the majority of morbidity and mortality from CVD. It has been consistently shown that the time period from the onset of an event to the time of intervention largely determines the subsequent course and outcome for a given patient. Necrosis of viable myocardial tissue begins 30 minutes after coronary artery occlusion and becomes substantial quickly. Minutes can matter in a heart attack.

While extensive efforts have been made to reduce the time from signs and symptoms to intervention, most current infrastructure relies primarily upon hospital based treatment. Thus, there remains an extended time period between initial symptoms and professional evaluation during which tissue injury progresses.

The present invention provides a kit and process for a patient to assess and initiate treatment of a myocardial ischemic event, prior to professional medical evaluation. Such a kit contains instructions and a set of medications for intervention, which can be administered by the affected individual or assistant. It is recognized that when a patient attempts to diagnose an ischemic event, there will be a proportion of events related to other causes. Thus, according to the present invention, the complication rate of intervention should be low and the benefit in treating ischemic events be high enough to overshadow potential complications and false diagnoses.

### SUMMARY OF THE INVENTION

The systems and methods for diagnosing and treating a myocardial ischemic event by an affected individual or assistant provides for improved care.

One aspect of the invention provides for a medical kit for assessing and treating a myocardial ischemic event. In particular, the medical kit of the invention provides a means for an affected individual or an assistant to assess and treat an ischemic event at the onset of symptoms. This may be completed prior to full professional evaluation. By providing a patient with a means for rapidly treating an ischemic event based on the probability of acute event soon after the onset of symptoms, the extent of damage can be minimized. Consequently, complications from the event, which may include loss of stamina, future related events, and death, may be minimized.

In some embodiments, the ischemic event treated is, for example, a heart attack (including myocardial infarct) or unstable angina. A preferred embodiment uses a protocol based diagnostic tool and an all-in-one case to support rapid and appropriate use of therapy.

In particular embodiments of the invention, the diagnostic modality may include a protocol which assesses symptoms and/or signs related to an ischemic event.

In particular embodiments of the invention, the treatment modality includes a set of medications. In some embodiments, the kit may include an aspirin, a beta-blocker, and/or whole or fractionated heparin or other anticoagulant medication. The kit may also include an anti-platelet agent, an analgesic, a vascular dilation agent, an angiotensin converting enzyme (ACE) inhibitor, ventilated oxygen, and/or a nitroglycerin compound.

Another aspect of the invention provides for a protocol containing instructions for a patient or assistant to assess symptoms and/or signs associated with an ischemic event and to determine the likelihood that the event is an ischemic event. This may be used to determine disease risk or an assigned risk category for the purpose of treatment evaluation.

In a particular embodiment, the protocol may contain inquiries for the patient to assess certain symptoms or signs associated with a myocardial ischemic event. For example, the assessment instructions may comprise a first inquiry as to whether the patient is experiencing chest pain similar to a previous heart attack; a second inquiry as to whether the patient is experiencing a pressing sensation of the chest; a third inquiry as to whether the patient is experiencing left arm pain, left arm numbness, chest tightness, pounding heart, sweating, a sense of impending doom, jaw pain, shortness of breath, neck pain, inappropriate sweating, or nausea; and a fourth inquiry as to whether the patient is experiencing an anxious or frightened feeling. In another aspect of the invention, the written protocol of the invention may be in the form of a schematic or flow chart diagram. The flow chart diagram may include a series of nodes, wherein each node describes a symptom associated with an ischemic event, and progress through the flow chart depends on the presence or absence of the symptoms resulting in an assigned risk category. This flow chart may be presented on paper, laminated paper, on an electronic screen, or other format. The chart may respond to the patients' answers and provide the next, relevant question on the page or screen, ultimately taking the patient through a standardized assessment. The protocol may also be in the form of a checklist.

In one embodiment of the invention, the written protocol for the medical kit of the invention is set forth in FIG. 4.

In another embodiment, the assessment instructions may include instructions for the patient to assess the presence, absence, degree and/or severity of symptoms or signs associated with an ischemic event and assign a category of risk based upon the assessment. The category of risk refers to the result of a risk stratification protocol or algorithm that estimates the likelihood that a patient is experiencing an ischemic event by evaluating, for example, the presence, absence, degree and/or severity, of the patient's symptoms. Accordingly, the category of risk may be assigned as, e.g., a numerical value, an assigned score, or a representative category, which may be correlated with an appropriate treatment regimen for the patient. Thus, depending on the category of risk assigned to a patient, an appropriate treatment regimen is recommended.

In a preferred embodiment, symptoms assessed within the ischemic event protocol may include: chest pain as experienced in a previous heart attack, a pressing sensation on the chest, chest pain, pallor, left arm pain, left arm numbness, a sense of impending doom, jaw pain, shortness of breath, neck pain, sweating/diaphoresis, nausea, an anxious feeling and/or a frightened feeling. In a preferred embodiment of the invention, the symptoms include chest pain, left arm pain, left arm numbness, and chest tightness.

In a preferred embodiment, signs assessed within the ischemic event protocol may include assessment of: visual appearance of the affected individual, cutaneous measurements, blood oxygen saturation, heart rate, blood pressure, respiratory rate, skin galvanic potential, electrocardiographic parameters, electroencephalographic signals, and measurement of serologic markers, including but not limited to troponin or a subset thereof and creatine kinase or a subset thereof.

In another embodiment, the written protocol contains treatment instructions, which may include directions for administration of one or more medications based on the assigned risk category. Alternatively, the treatment instructions may include directions for administration of one or more medications based on an assigned score. Such treatment instructions may comprise, for example, a first category with instructions to immediately contact a healthcare provider; a second category with instructions to treat with an aspirin tablet and immediately contact a healthcare provider; a third category with instructions to treat with an aspirin and a beta-blocker and immediately contact a healthcare provider; and a fourth category with instructions to treat with an aspirin or other antiplatelet agent, clopidogrel, a beta blocker, and heparin, fondaparinux or other anticoagulant and immediately contact a healthcare provider.

In another aspect of the invention, a device is provided that supports convenient carrying and use of diagnostic and therapeutic modalities. The device may include a container which holds further individual wrapping for medications and clear instructions for the patient assessment and administration of the medications. In yet another aspect, the medical container of the invention includes a pre-filled and ready to use syringe or syringes containing subcutaneous administered medications.

In one embodiment, the device includes a mechanism for measuring signs related to an ischemic event. Signs may include cutaneous or invasive measurement. Measurements may include a blood based point of care test, for example, a test for determining the patient's blood myoglobin, troponin or creatine kinase-MB (CKMB) level, or other suitable marker of ischemia.

The present invention provides a method of using a medical kit described herein, wherein the method includes determining whether a patient is at risk for having an ischemic event, prescribing a medical kit for a patient at risk for having an ischemic event, and instructing the patient on how to use the medical kit.

The forgoing and other aspects, embodiments, and features of the teachings can be more fully understood from the following description in conjunction with the accompanying drawings. In the drawings, like reference characters generally refer to like features and structural elements throughout the various figures. The drawings are not necessarily to scale, emphasis instead being placed upon illustrating the principles of the teachings.

### BRIEF DESCRIPTION OF THE DRAWING

These and other aspects of the invention will be apparent to the skilled artisan from the description below and from the drawings, which are meant to illustrate and not to limit the invention, and in which:

FIG. 1 is a schematic representation of a medical kit of the invention, including a container 1 which contains a protocol with instructions and medications.

FIG. 2 is a schematic overhead view of a medical kit of the invention, containing a set of medications in pill or injectable form 2-5. These medications may include aspirin 2, anti-platelet medication 3, morphine or other pain medication 4, anti-hypertension medication 4, and heparin or other anticoagulant 5 (FIG. 2).

FIG. 3 is a schematic view of a patient controlled syringe. The syringe 6 contains a pressure sensitive needle 7 which releases a spring-linked plunger mechanism 8 to automatically inject medication upon appropriate contact with a cutaneous surface. The syringe may also be a standard syringe pre-filled with the correct dose of medication.

FIG. 4 is an example of a protocol that may be used in the medical kit of the invention in the form of a flow chart diagram.

FIG. 5 is an example of a protocol that may be used in the medical kit of the invention in the form of a point based algorithm.

### DETAILED DESCRIPTION OF CERTAIN PREFERRED EMBODIMENTS

Advantages of the described system and kit include, but are not limited to, a patient initiated assessment of the patient's symptoms and instructions for determining next steps based on the likelihood that an ischemic event has occurred. The medical kit of the invention provides a methodical approach for the patient to appropriately manage early ischemic event intervention and reduce the time for an effective and medically relevant response to be initiated. Thus, the medical kit of the invention provides the opportunity to significantly reduce morbidity and mortality of the number one U.S. killer.

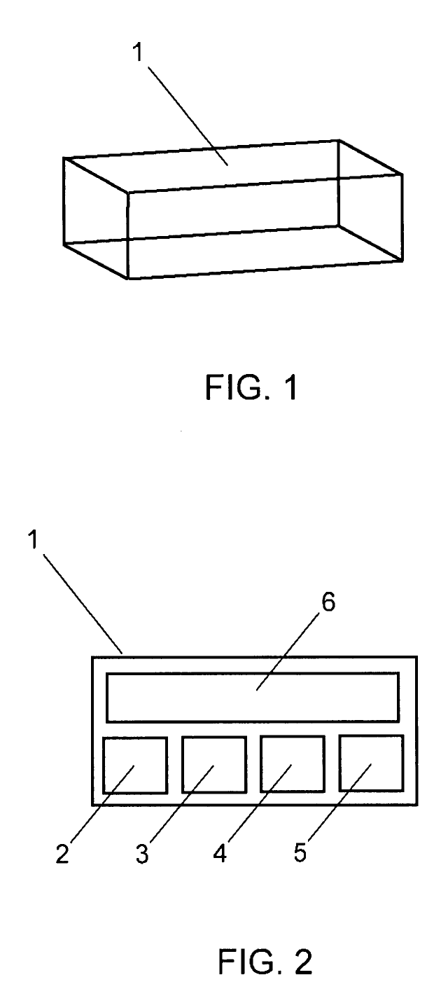

The present invention provides a medical kit for use by a patient in the assessment and treatment of an ischemic event. The medical kit of the invention includes a written protocol with assessment instructions for a patient to assess symptoms associated with an ischemic event, treatment instructions based on the likelihood that the symptoms are from an ischemic event, and a set of medications for treating the ischemic event according to the treatment instructions for the level of risk (FIG. 1). As used herein the term “kit” includes any manufacture (e.g. a package or container), system, or device comprising the components described herein, the manufacture being promoted, distributed, or sold as a unit for performing the methods of the present invention. As used herein, the term “ischemic event” may encompass, for example, a heart attack, myocardial ischemia, angina pectoris, limb ischemia, or other vascular thromboembolic or stenotic phenomenon.

Method of Using the Medical Kit of the Invention

The present invention provides also a method of using a medical kit described herein, wherein the method includes determining whether a patient is at risk for having an ischemic event, prescribing a medical kit for a patient at risk for having an ischemic event, and instructing the patient on how to use the medical kit. In particular, the medical kit of the invention is prescribed to a patient at risk for having an ischemic event, e.g., males over 55 years of age or individuals who have previously experienced an ischemic event. The kit is designed such that medications and other therapies are released only to a given patient or predetermined set of patients. As used herein, the term “patient” may include, but is not limited to, an individual that has experienced a previous ischemic event or is at risk for having an ischemic event, an individual experiencing symptoms associated with an ischemic event, an individual that believes that he/she could be experiencing an ischemic event, or a user that is assisting the individual who is experiencing symptoms associated with an ischemic event. A physician may perform an initial evaluation of the patient to determine whether the kit is appropriate for the patient. The following inquiries may be relevant as to whether a patient should be prescribed the medical kit of the invention, but are not the only inquiries relevant: Is the patient a man over 45 or a woman over 55; Does the patient smoke and in particular has the patient been smoking even a few cigarettes in the past week; Has the patient been told that he/she has diabetes; Has the patient been told that he/she has a high cholesterol; Has the patient been told that he/she has a high blood pressure; and Did any man in the patient's family have a heart attack before the age 55 or any woman have a heart attack before the age of 65.

Onset of Symptoms Associated with an Ischemic Event

In response to the first symptoms of ischemia, the patient considers use of the medical kit of the invention. A clear set of instructions on the external surface of the kit describes warning symptoms and signs for the ischemic state for which it is recommended. Such symptoms associated with the ischemic event may include: chest pain as experienced in a previous heart attack, a pressing sensation on the chest, chest pain, pallor, left arm pain, left arm numbness, a sense of impending doom, jaw pain, shortness of breath, neck pain, sweating/diaphoresis, nausea, an anxious feeling and/or a frightened feeling. In a preferred embodiment of the invention, the symptoms include chest pain, left arm pain, left arm numbness, and chest tightness. In a further embodiment, the medical kit includes assessment of cutanous measurements, blood oxygen saturation, heart rate, blood pressure, respiratory rate, skin galvanic potential, electrocardiographic parameters, electroencephalographic signals, and measurement of serologic markers, including troponin or a subset thereof and creatine kinase or a subset thereof.

Protocol

After the kit is opened, the patient reviews an attached protocol specified for the patient and performs an assessment to define the likelihood that his/her symptoms represent an ischemic event, which entails a set of easy step by step instructions. Based on information provided, the kit may clearly describe the likelihood that his/her symptoms represent an ischemic event or may only delineate next steps. The kit of the invention may comprise a clear set of instructions on the external surface of the kit, which describes the warning symptoms and signs for the specific ischemic state for which it is recommended. The instructions of the medical kit may include a pull-out instruction set, which may be laminated or on an embedded electronic touch screen. In other embodiment, the instructions may be on the lid of the medical kit.

The assessment instructions may contain inquiries for the patient to assess certain symptoms associated with an ischemic event. For example, the assessment instructions may comprise a first inquiry as to whether the patient is experiencing chest pain similar to a previous heart attack; a second inquiry as to whether the patient is experiencing a pressing sensation of the chest; a third inquiry as to whether the patient is experiencing left arm pain left arm numbness, chest tightness, pounding heart, sweating, a sense of impending doom, jaw pain, shortness of breath, neck pain, inappropriate sweating, or nausea; and a fourth inquiry as to whether the patient is experiencing an anxious or frightened feeling.

Further components of the medical kit may include diagnostic tests, such as a point of care test, for determining myoglobin, troponin, or creatine kinase-MB levels or other suitable marker for ischemia. The medical kit also contains a set of medications that are proven effective for treating ischemic events.

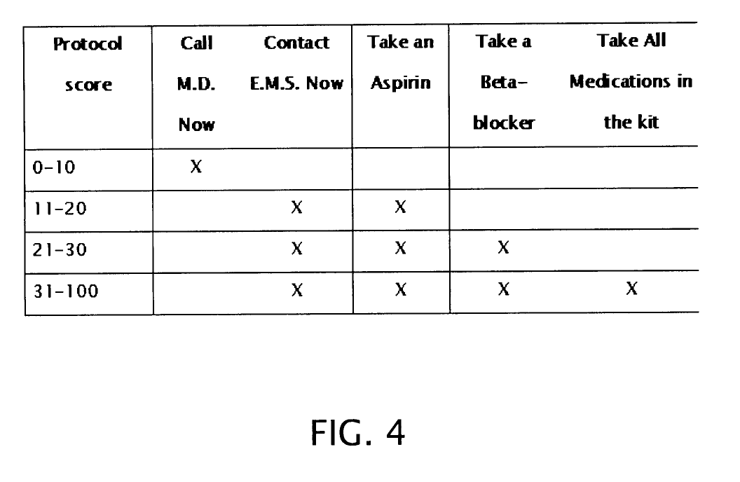

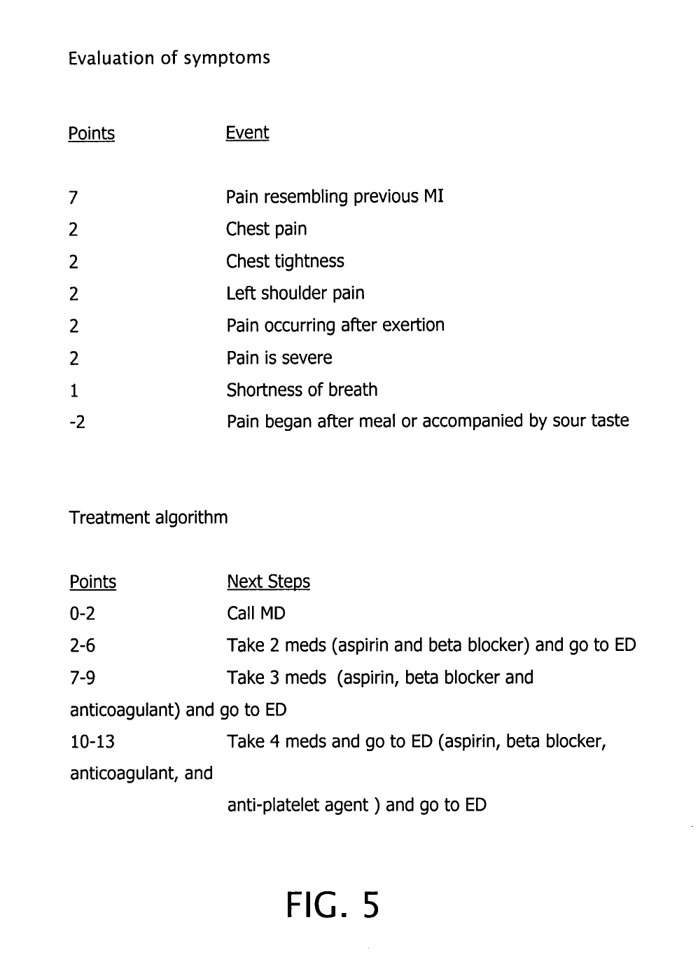

In another embodiment, the assessment instructions may include instructions for the patient to assess the presence or absence of the symptoms associated with a myocardial ischemic event and assign a score based upon the presence or absence of the symptoms. In another aspect of the invention, the written protocol of the invention may be in the form of a flow chart diagram. The flow chart diagram may include a series of nodes, wherein each node describes a symptom associated with an ischemic event, and progress through the flow chart depends on the presence or absence of the symptoms resulting in an assigned risk category. In one embodiment of the invention, the written protocol for the medical kit of the invention is set forth in FIG. 4. In one embodiment of the invention, the written protocol for the medical kit of the invention is set forth in FIG. 5.

Based on the answers to a series of inquiries, and in certain circumstances the results of diagnostic tests included in the medical kit, the patient's likelihood to be experiencing an ischemic event is determined. As used herein, the term “category of risk” or “assigned risk category” refers to the result of a risk stratification protocol or algorithm that estimates the likelihood that a patient is experiencing an ischemic event by evaluating the presence, absence, degree and/or severity of the patient's symptoms. Therefore, the medical kit of the invention provides instructions for a patient to assign a category of risk based on the assessment of the patient's symptoms. In particular, the category of risk may be assigned as, e.g., a numerical value, an assigned score, a representative category, or a level of risk, which may be correlated with an appropriate treatment regimen and next steps for the patient. Thus, depending on the category of risk assigned to a patient, an appropriate treatment regimen is recommended.

In another aspect of the invention, the written protocol contains treatment instructions, which may include instructions for administration of one or more medications based on the assigned risk category. Alternatively, the treatment instructions may include instructions for administration of one or more medications based on the assigned score. For patients assigned a high risk category, the instructions may suggest administering all medications within the kit and immediately contacting a health care provider such as paramedics, or going directly to an emergency room or hospital. For patients assigned a medium category of risk, some or all of the medications in the kit may be recommended, with immediate follow up with a health care provider. For patients assigned a low category of risk, the instructions may suggest a phone call to the primary care physician or other less urgent follow up. The protocol of the medical kit may be capable of adjusting responses based on medications that the patient has already taken, as well as known drug allergies to avoid adverse drug reactions.

Medical Kit for Myocardial Infarction

In one embodiment, the medical kit of the invention is tailored for myocardial infarction and thus the assessment instructions and treatment instructions may be specifically tailored to treat a myocardial infarction. For example, in one aspect, the assessment instructions may include assessing cutaneous measurements, blood oxygen saturation, heart rate, blood pressure, respiratory rate, skin galvanic potential, electrocardiographic parameters, electroencephalographic signals, and measurement of serologic markers, e.g., troponin or a subset thereof and creatine kinase or a subset thereof. The treatment instructions may include non-medication interventions, e.g., oxygen and cessation of physical exertion. The treatment instructions may also include the administration of medications included in the kit, such as, anti-platelet agents, anticoagulants, analgesics, antihypertensives, nitroglycerin and heart rate control medications. In one embodiment, the medical kit of the invention features medications including aspirin 2, other anti-platelet medication 3, a pain medication 4, anti-hypertension medication 5, and heparin, fondaparinux or other anticoagulant 6 (FIG. 2).

Medications

The medical kit of the present invention may include a plurality of medications, including anti-platelet compounds (e.g., aspirin or acetylsalicylic acid), anti-coagulants (e.g., heparin including low molecular weight heparin, whole heparin and fractionated heparin, and fondaparinux), nitrates, magnesium, analgesics and benzodiazepines. Additional medications provided in the present invention are beta-blockers, and ACE inhibitors.

Antiplatelet agents

Oral antiplatelet agents have been established as essential in the management of a heart attack victim and these specifically include acetylsalicylic acid (aspirin) and clopidogrel (plavix). Aspirin irreversibly inhibits platelet cyclo-oxygenase, which subsequently prevents the formation of thromboxane A₂. This, in turn, impairs platelet aggregation. Clopidogrel inhibits adenosine diphosphate (ADP)-mediated platelet aggregation. One study has shown that aspirin can reduce the risk of death by up to 23% if administered when a heart attack is suspected and for 30 days thereafter. This represents a potential for saving 10,000 lives per year in the United States alone. Clopidogrel has been found to be effective in reducing the combined risk of ischemic stroke, heart attack, or death from vascular disease and is therefore a medication candidate for emergency treatment of stroke, heart attack or vascular disease during the first hours. However, because aspirin and clopidogrel affect platelet function by different mechanisms, they may be usable in combination to achieve greater benefit. Accordingly, aspirin and clopidogrel each make an excellent candidate for inclusion in the medical kit of the present invention because each medication may provide a substantially immediate benefit to a victim of an ischemic event. A preferred embodiment may include 325 mg of chewable aspirin with or without one or more 75 mg clopidogrel pills.

Anticoagulants

Anticoagulants that may be used in the medical kit of the invention can include, but are not limited to, fondaparinux, heparin, and low molecular weight heparin. A preferred embodiment may include 2.5 mg of injectable fondaparinux.

Beta-blockers

Beta-blockers that may be used in the medical kit of the invention can include, but are not limited to, propranolol, nadolol, timolol, pindolol, acebutolol, labetalol, sotalol, oxprenolol, esmolol, carvedilol, metoprolol and atenolol. A preferred embodiment may include 25 mg or 50 mg of ingestible metoprolol.

ACE inhibitors

Angiotensin-converting enzyme inhibitors, (ACE) inhibitors, can be helpful early in the treatment of a heart attack, often after thrombolytic therapy has been given and the blood pressure is known to be stable. Benefits of ACE inhibitors include suppression of the sympathetic and renin-angiotensin systems, and enhanced collateral coronary blood flow in addition to ventricular remodeling. Patients with conditions such as anterior wall myocardial infarction, previous infarction, congestive heart failure, or tachycardia seem to derive greater benefit from treatment with ACE inhibitors. ACE inhibitors that may be used in the present invention include, but are not limited to, capoten, enalapril, fosinopril, benzapril, moexipril, perindopril, quinapril, ramipril, and trandopril.

Magnesium

Magnesium has several potential mechanisms of action that can benefit a victim of an ischemic event. It can decrease the rate of arrhythmias by enhancing membrane stability and reducing the effects of free radicals. It also causes coronary vasodilatation, afterload reduction, calcium antagonism, and has antiplatelet activity.

Nitrates

Nitrates have the effect of relaxing vascular smooth muscles, which helps to dilate both arterial and venous beds, although venous effects predominate. Nitroglycerin is a commonly recommended nitrate that provides dilation of post capillary vessels, including large veins, promotes peripheral pooling of blood, decreases venous return to the heart, and reduces left ventricular end-diastolic pressure (preload). Nitroglycerin also produces arteriolar relaxation, thereby reducing peripheral vascular resistance and arterial pressure (afterload), and dilates large epicardial coronary arteries. The use of nitrates upon the onset of heart attack symptoms has long been recommended. Thus, nitrates that may be used in the medical kit of the present invention include nitroglycerine, isosorbide dinitrate, isosorbide mononitrate, or other nitrate compound.

Delivery Mechanisms

The medications in the medical kit of the present invention may include a variety of delivery mechanisms. In other embodiments, one or more medications may be combined into: a single pill, a capsule, a syringe, a transdermal patch, chewing gum containing medications, e.g., by chewing the medications may be administered to the patient, or candy containing medications, e.g., by sucking the medications may be administered to the patient. In another embodiment, the medical kit of the invention may provide a non-enteric coated aspirin for fast absorption. The kit may further comprise an automatic pill dispenser or pills may be provided in blister packs.

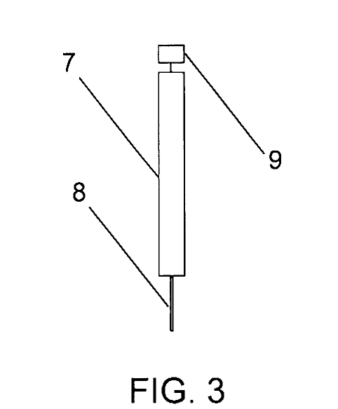

It is anticipated that injectable medications, such as an anticoagulant, may be necessary for several treatable ischemic states. The medical kit of the invention is designed to improve the likelihood of successful self-administration of injectable medications (FIG. 3). As such, the system of packaging and administration of injectable medications allows for clear instructions and easy injection. In one embodiment, a standard syringe will be used to maximize patient familiarity with the device. In another embodiment, a pre-filled syringe will be pressure sensitive, automatically piercing skin and releasing its contents upon contact with a cutaneous surface. Thus, in one embodiment, the syringe is designed for patient control and is fully preassemebled with medication and needle. In yet another embodiment, the syringe has easy to use handle(s) and plunger mechanism(s). In still another embodiment, the syringe is point and shoot, where upon sensing pressure, the syringe automatically plunges and releases its contents. Thus, the syringe will not fire without cutaneous contact. Moreover, the syringe and medication may be designed to be effective with subcutaneous release in muscle groups and/or in fat pads. In another embodiment, the kit includes a mechanism for pressing a series of buttons for dispensing the medication and an automatic dispensing syringe. This type of one-step system will be critical for patient compliance with potentially life saving therapy.

In another embodiment, the doses of the medications in the kit, such as heparin, are based on the weight of the patient. Thus, in some embodiments, the medical kits may vary according to the doses of medications contained within the kit.

In another embodiment, the medical kit of the invention provides a mechanism, which is capable of tabulating the medications and doses that have been removed by the patient.

It will be appreciated that in certain instances, the patient will use the medications in the medical kit of the invention to treat a confounding condition. For example, the medical kit of the invention may include an antacid in order to assess the likelihood of gastrointestinal upset.

It is anticipated that further medical management may be necessary depending on the symptoms of the patient, as well as, the results of diagnostic tests. In one preferred embodiment, the kit will be tailored to automatically contact Emergency Medical Services, the patient's physician(s), or other medical personnel as appropriate.

Carry Case for Medical Kit

According to the present invention, a patient that has had a previous ischemic event or is at high risk of an ischemic event would carry the medical kit of the invention in, for example, a carrying case (see FIG. 1). The carrying case may completely enclose the medical kit or enclose only a portion of the medical kit. The medical kit can be provided for everyday availability or could be provided to a patient, temporarily, if the patient will be far from medical attention, e.g., in a remote area. Thus, the kit of the invention is portable so that it can be carried by the patient or an assistant. In one embodiment, the carrying case or medications are dated to assure that the medications in the kit are effective. The carrying case of the kit may include a means for electronically conveying when a medication or case replacement is necessary. In one embodiment, the carrying case may be sealed and intended for one-time use. Alternatively, the carrying case may be resealable and intended for one or more uses. In another aspect, the carrying case may include a mechanism to prolong medication lifespan. In still another aspect, the carrying case may include a locking device or code for purposes of being child proof. In another aspect the kit may have various choices for an opening device dependent on which level of risk or how the patient has answered the risk assessment questions. The case may open to reveal one, some or all the medications, depending on the patient's risk assessment.

Devices

The invention also features a device which assists the patient in assessing and treating a myocardial ischemic event. The device may include a protocol, e.g., in written or electronic form, which includes instructions for assessing symptoms associated with an ischemic event and assigning a category of risk for the ischemic event, and instructions for treating the ischemic event based on the assigned risk category. The device may also include a mechanism to contact health care providers by, for example, connecting with an existing phone line or internet connection. The device may also be capable of storing phone numbers and dialing a particular phone number based on the patient's assigned category of risk.

In another embodiment, the medical kit of the invention may contain a point of care device to assist in determining the patient's risk of myocardial ischemia. The device may use serum markers, such as myoglobin, creatine kinase, creatine kinase MB, or troponin to better assess the likelihood a patient is experiencing myocardial ischemia.

In another embodiment, the medical kit of the invention may contain a wireless emergency communication device, including a global positioning device. Thus, in one aspect, a patient who opens a medical kit of the invention may automatically trigger a signal requesting an emergency medical service. Patients who, for example, collapse at the onset of symptoms would benefit from such a component within the medical kit.

In another embodiment, the container for the medications and/or instructions is constructed to withstand a variety of environmental conditions so that the instructions and medications are effective in a variety of regions throughout the world. In another embodiment the kit is manufactured to withstand combat conditions. In another embodiment the instructions are presented or made in more than one language. In another embodiment, the kit is tailored for patients anticipated to have difficulty in obtaining professional medical care within a given time period.

### EXAMPLES

Aspects of the present teachings may be further understood in light of the following examples, which are not exhaustive and which should not be construed as limiting the scope of the present teachings in any way.

### Example 1

Written Protocol with Inquiries for the Patient

In one embodiment of the present invention, the written protocol of the medical kit comprises assessment instructions with a series of inquiries for the patient. In particular, the assessment instructions include instructions for the patient to assess the presence or absence of symptoms associated with an ischemic event. The assessment instructions may contain a number of inquiries as to the patient's symptoms. For example, the assessment instructions may include the following inquiries:

A first inquiry, whether the patient is experiencing chest pain similar to a previous heart attack; A second inquiry, whether the patient is experiencing a pressing sensation on the chest; A third inquiry, whether the patient is experiencing: left arm pain, left arm numbness, chest tightness, pounding heart, sweating, a sense of impending doom, jaw pain, shortness of breath, neck pain, inappropriate sweating, or nausea; and A fourth inquiry, whether the patient is experiencing an anxious or frightened feeling.

The inquiries in the medical kit may, for example, be in the form of Yes/No questions. Based on the patient's response to the above set of inquiries, the patient is assigned a risk category for the ischemic event.

The medical kit of the present invention may further comprise treatment instructions, wherein the patient is instructed to administer one or more medications from the kit based upon the likelihood of a myocardial ischemic event. Thus, the treatment instructions may, for example, instruct the patient as follows:

A first category with instructions to immediately contact a healthcare provider; A second category with instructions to treat with an aspirin tablet and immediately contact a healthcare provider; A third category with instructions to treat with an aspirin and a beta-blocker and immediately contact a healthcare provider; and A fourth category with instructions to treat with an aspirin, a beta-blocker, and heparin or another anti-coagulant, and immediately report to a medical treatment facility.

### Example 2

Protocol in the Form of a Flow Chart Diagram

In one embodiment of the present invention, the written protocol of the medical kit comprises assessment instructions in a flow chart diagram (FIG. 4). FIG. 4 depicts a protocol for a medical kit of the invention, including the assessment and treatment instructions. The flow chart diagram may include a series of nodes, wherein each node comprises a symptom associated with an ischemic event. The patient's progress through the flow chart depends on the presence or absence of the patient's symptoms and results in an assigned risk category. Thus, based on the patient's assigned a risk category, the flow chart provides the appropriate treatment instructions.

### Example 3

Protocol in the Form of a Weighted Scale

In one embodiment of the present invention, the written protocol of the medical kit comprises assessment instructions with a series of inquiries for the patient as set forth in Example 1. The inquiries in the medical kit may, for example, be in the form of Yes/No questions. Based on the patient's response to the above set of inquiries, the patient is assigned a score that corresponds to the risk category for the ischemic event. A point system may be used to define risk categories as in FIG. 5.

The medical kit of the present invention may further comprise treatment instructions as set forth in Example 1.

The patient's responses to each inquiry are compiled and result in an assigned score (see Table 1). Thus, if the total assigned score is, for example, between 0 and 10, the patient is instructed to immediately contact a physician. If the total assigned score is, for example, between 11 and 20, the patient is instructed to take an aspirin and seek emergency medical treatment immediately. If the total assigned score is, for example, between 21 and 30, the patient is instructed to take an aspirin and a beta-blocker and seek emergency medical treatment immediately. If the total assigned score is, for example, between 31 and 100, the patient is instructed to take all medications provided in the kit, e.g., an aspirin, a beta-blocker and an anticoagulant, and to immediately report to a medical treatment facility.

### Example 4

Set of Medications Tailored to Reduce Bleeding Risk

In one embodiment of the present invention, the set of therapeutic medications will be targeted to reduce bleeding risk that may result from taking medications. It is recognized that a major concern of the patient and treating physician will be risk of bleeding from anticoagulation, which in its most severe form may include life-threatening hemorrhage or stroke. In one embodiment, medications will be chosen to minimize this risk. In one embodiment, the set of medications and dosages is selected based on a likely subsequent angioplasty or other procedure.

These medications may include, but are not limited to, aspirin and an anticoagulant. The anticoagulant may specifically be fondaparinux to minimize risk of hemorrhagic complications. A beta blocker and anti-platelet agent may be added for potential reduction in cardiac risk.

In one embodiment, the kit may contain 325 mg chewable aspirin and 2.5 mg of injectable fondaparinux. In addition, clopidogrel may be included as one or more 75 mg tablets. In addition, metoprolol may be included as a 50 mg or 100 mg tablet.

The medical kit of the present invention may further comprise treatment instructions as set forth in Example 1.

Other Embodiments

Those skilled in the art will recognize, or be able to ascertain using no more than routine experimentation, many equivalents to the specific embodiments of the invention described herein. Such equivalents are intended to be encompassed by the following claims.

What is claimed is:

1. A medical kit for use by a patient for assessing and treating a myocardial ischemic event, the kit comprising:
(a) a written protocol comprising
(1) instructions for assessing symptoms associated with a myocardial ischemic event to assign a category of risk for the ischemic event; and
(2) instructions for treating the ischemic event based on the assigned risk category; and
(b) a set of medications for treating the ischemic event according to the treatment instructions appropriate for the likelihood that the symptoms reflect a myocardial event.

2. The kit of claim 1, wherein the ischemic event is a heart attack.

3. The kit of claim 1, wherein the symptoms are selected from the group consisting of: chest pain as experienced in a previous heart attack, a pressing sensation on the chest, chest pain, left arm pain, left arm numbness, chest tightness, pounding heart, sweating, sense of impending doom, jaw pain, shortness of breath, neck pain, inappropriate sweating, nausea, an anxious feeling, and a frightened feeling.

4. The kit of claim 1, wherein the symptoms are selected from the group consisting of: chest pain, chest tightness, sensation similar to a previous heart attack, and left arm pain or numbness.

5. The kit of claim 1, wherein the written protocol comprises: instructions for a patient to determine whether he/she is experiencing symptoms associated with an ischemic event and to assign a category of likelihood that the symptoms reflect a myocardial event based upon the symptoms experienced; and instructions for treatment based upon the likelihood of an ischemic event

6. The kit of claim 1, wherein the assessment instructions comprise instructions for the patient to assess the presence or absence of the symptoms associated with an ischemic event and assign a score based upon the presence or absence of the symptoms.

7. The kit of claim 6, wherein the assessment instructions comprise the following inquiries: a first inquiry, whether the patient is experiencing chest pain similar to a previous heart attack; a second inquiry, whether the patient is experiencing a pressing sensation on the chest; a third inquiry, whether the patient is experiencing: left arm pain, left arm numbness, chest tightness, pounding heart, sweating, a sense of impending doom, jaw pain, shortness of breath, neck pain, inappropriate sweating, or nausea; and a fourth inquiry, whether the patient is experiencing an anxious or frightened feeling.

8. The kit of claim 1, wherein the protocol is set forth in a flow chart diagram.

9. The kit of claim 8, wherein the flow chart diagram comprises a series of nodes, wherein each node comprises a symptom associated with an ischemic event and progress through the flow chart depends on the presence or absence of the symptoms resulting in an assigned risk category.

10. The kit of claim 5, wherein the treatment instructions comprise instructions for administration of one or more medications based upon the assigned risk category.

11. The kit of claim 6, wherein the treatment instructions comprise instructions for administration of one or more medications based on the assessed likelihood of an ischemic event.

12. The kit of claim 9, wherein the treatment instructions comprise instructions for administration of one or more medications based upon the assigned risk category.

13. The kit of claim 1, wherein the set of medications comprises an aspirin, a β-blocker, and an anticoagulant.

14. The kit of claim 13, wherein the set of medications further comprises, an antiplatelet agent, an ACE inhibitor, or a nitroglycerin compound.

15. The kit of claim 6, wherein the treatment instructions comprise: a first category with instructions to immediately contact a healthcare provider; a second category with instructions to treat with an aspirin tablet and immediately contact a healthcare provider; and a third category with instructions to treat with aspirin, a beta-blocker, and an anticoagulant and immediately contact a healthcare provider.

16. The kit of claim 9, wherein the treatment instructions comprise: (a) a first category with instructions to immediately contact a healthcare provider; (b) a second category with instructions to treat with an aspirin tablet and immediately contact a healthcare provider; (c) a third category with instructions to treat with an aspirin, a beta-blocker, and an anticoagulant and immediately contact a healthcare provider.

17. The kit of claim 1, further comprising a point of care test.

18. The kit of claim 17, wherein the point of care test is selected from the group consisting of myoglobin, creatine kinase-MB (CKMB), and troponin.

19. A method of using the kit of claim 1, the method comprising: (a) determining whether a patient is at risk for having an ischemic event; (b) prescribing the kit of claim 1 to the patient if the patient is a risk for having an ischemic event; and (c) instructing the patient on how to use the kit of claim 1.

20. A medical kit for use by a patient for assessing and treating a myocardial ischemic event, the kit comprising: (a) a protocol comprising (1) instructions for assessing symptoms associated with an ischemic event to assign a category of risk for the ischemic event; and (2) instructions for treating the ischemic event based on the assigned risk category; wherein the protocol is in an electronic form; and (b) a set of medications for treating the ischemic event according to the treatment instructions for the assigned risk category.

21. The kit of claim 1, further comprising: (a) a carrying case wherein each medication is stored and labeled; and (b) individual wrapping and clear instructions for oral medications.

22. A medical kit for use by a patient for assessing and treating a heart attack, the kit comprising: (a) a written protocol comprising (1) instructions for the patient to assess the presence or absence of symptoms associated with a myocardial ischemia and assign a category of likelihood based upon the presence or absence of the symptoms; and (2) instructions for treating the heart attack based on the assigned risk category, wherein the treatment instructions comprise: (a) a first category with instructions to immediately contact a healthcare provider; (b) a second category with instructions to treat with one or more medications and immediately contact a healthcare provider; and (c) a third category with instructions to treat with one or more medications and immediately contact a healthcare provider.

23. The kit of claim 22, wherein the instructions to treat with a set of medications comprise: instructions to treat with an aspirin tablet and immediately contact a healthcare provider; instructions to treat with an aspirin and a beta-blocker and immediately contact a healthcare provider; and instructions to treat with an aspirin, a beta-blocker, and heparin or other anticoagulant and immediately contact a healthcare provider

24. The kit may contain an opening mechanism that provides varying access to the medications contained within the kit, dependent upon the patient's answers to the assessment of likelihood of an event. The kit may therefore open to reveal only one, or some, or all of the medications for the patient's use, with this unique opening mechanism.
